(19) United States
(12) Patent Application Publication
(10) Pub. No.: US 2026/0282118 A1
(43) Pub. Date: Sep. 17, 2026

(54) PAYLOAD-BASED DIVERSITY SWITCHING FOR SATELLITE OPTICAL FEEDER-LINKS

(71) Applicant: Hughes Network Systems, LLC, Germantown, MD (US)

(72) Inventors: Satyajit Roy, Gaithersburg, MD (US); George Joseph Choquette, Potomac, MD (US)

(21) Appl. No.: 19/032,703

(22) Filed: Jan. 21, 2025

(51) Int. Cl. H04W 76/10; H04B 10/2507; H04B 17/391

(52) U.S. Cl. CPC H04W 76/10; H04B 10/2507; H04B 17/3912

(57) ABSTRACT

Techniques are described for implementing space-frequency diversity in a satellite network system using an optical feeder-link band. Embodiments enable very rapid diversity switching among RF Gateway sites by placing the diversity switching decision and implementation within the satellite payload. Some space-frequency diversity implementations described herein can provide additional diversity, such as time diversity, angle diversity, and/or site diversity. Techniques described herein can be applied to millimeter-wave RF bands, such as E-band and higher.

### BACKGROUND

Optical Wireless Communication (OWC), also called free space optical (FSO) communication, has recently evolved in significant ways, and is now employed in a wide range of terrestrial and space applications. Examples include optical intersatellite links (ISLs) for Low-Earth-Orbit (LEO) satellites, airborne or terrestrial optical wireless links for backhaul and/or fronthaul networks, indoor visible light communications, etc. However, OWC has tended not to be used for ground-to-satellite communications. For example, with conventional OWC approaches, clouds impairments and other environmental factors can result in optical feeder link outages that are so frequent as to be practically unusable for ground-to-satellite communications.

### BRIEF SUMMARY

Systems and methods are described herein for implementing space-frequency diversity in a satellite network system using an optical feeder-link band. Embodiments enable very rapid diversity switching among RF Gateway sites by placing the diversity switching decision and implementation within the satellite payload. Some space-frequency diversity implementations described herein can provide additional diversity, such as time diversity, angle diversity, and/or site diversity. Techniques described herein can be applied to millimeter-wave RF bands, such as E-band and higher.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of an illustrative implementation of a satellite with payload-based diversity switching for optical feeder-links, according to embodiments described herein.

FIGS. 2A and 2B illustrate forward and return communication directions, respectively in a system topology that facilitates protocol division between distributed gateway sites and a central site, according to embodiments described herein.

FIG. 3 illustrates a system topology depicting an alternative architecture where modulation and demodulation functions are performed at distributed gateway terminals, according to embodiments described herein.

FIG. 4 illustrates a system topology depicting the full replication of the feeder link model in a satellite communication network utilizing free-space optical (FSO) feeder links, according to embodiments described herein.

FIG. 5 illustrates a sample receive architecture to implement rapid, dynamic payload-side selection for extracting a best signal from among multiple redundant uplinks.

FIG. 6 shows a flow diagram of a method for payload-based diversity switching for satellite optical feeder-links, according to embodiments described herein.

FIG. 7 provides a schematic illustration of an embodiment of a computational system that can implement various system components and/or perform various steps of methods provided by various embodiments.

### DETAILED DESCRIPTION

Optical Wireless Communication (OWC), also called free space optical (FSO) communication, has recently evolved in significant ways, and is now employed in a wide range of terrestrial and space applications. It is recognized that use of OWC for optical feeder links can increase capacity in satellite communication networks, both in geosynchronous Earth orbit (GEO) and non-geosynchronous orbit (NGSO) contexts. Further, an optical spacelink offers the use of unlicensed spectrum and has much larger bandwidth than legacy Radio Frequency (RF) systems, such that it is naturally more secure with low probability-of-interception. However, conventional FSO approaches have tended not to be used for ground-to-satellite communication at least because there tend to be excessive optical feeder link outages in the presence of typical cloud impairments and other environmental factors.

Some state-of-the-art satellite communication systems are being designed to operate at Terahertz (THz) or near-THz RF bands, which can support wide bandwidth and large capacity and throughput. When compared with such systems, FSO-based approaches can provide both advantages and disadvantages. One advantage is that because of highly directive nature of FSO communication that can form pencil like beams, FSO can provide more transmission gain than THz RF. Another advantage is that FSO has less free path propagation loss than THz RF, and so can be used for long-distance communication without requiring large output power, whereas THz RF transceivers are output power limited. Another advantage is that because of highly directive line-of-sight (LoS) nature of FSO, higher spatial resolution exists in FSO communication than in THz RF, which enables better frequency reuse and removes constraints on RF gateway placement. Another advantage is that interference between an FSO link and any adjacent RF links (space or terrestrial) is relatively minimal compared to that of a typical THz RF link. Another advantage is that assuming that a user access link will remain at Ka-band, and given that the optical band is used for the feeder link (as opposed to using the Ka-band), more spectrum can be available for the user link than in traditional satellite communication cases.

A disadvantage of FSO-based approaches relative to THz RF approaches is that it is relatively difficult to align transmit and receive beams (pointing error is very high) for FSO links, which can reduce channel performance. Another disadvantage is that FSO links can be extremely susceptible to atmospheric and weather phenomenon, such as atmospheric turbulence and scintillations, clouds, fog, rain attenuation etc.

Embodiments described herein seek to overcome these and other conventional disadvantages to be able to effectively use FSO link communications to provide extremely high-capacity optical feeder links between satellite and ground segments of a satellite communication network. Some critical factors for satellite design are referred to as size, weight, and power (SWaP) requirements. For example, SWaP requirements can define size constraints (e.g., physical dimensions, volume, compactness, etc.), weight constraints (e.g., mass, launch weight, weight distribution, etc.), and power constraints (e.g. energy consumption, power generation, power storage, power efficiency, etc.). Optimizing the feeder link can help to reduce SWaP requirements, which can provide several features, such as reduced launch and operational costs, increased orbital maneuverability, increased operational lifespan, improved payload capacity, etc.

As noted above, a primary challenge for deploying FSO link communications as the satellite feeder link is degradation of the links due to atmospheric impairments. As used herein, the term “atmospheric impairments” generally includes any types of clouds impairments and other atmospheric and weather conditions (e.g., fog, rain, etc.) that can degrade FSO link communications. Diversity approaches can be used to address concerns relating to atmospheric impairments. In context of satellite communications, “diversity” can include one or more techniques for mitigating the effects of signal degradation. For example, diversity can include spatial diversity, which uses multiple antennas spaced apart at different locations to reduce the impact of fading and interference (e.g., and/or site diversity, which includes receiving the same signals by multiple ground stations located in different geographical areas); frequency diversity, which communicates the same information over multiple frequency channels to mitigate frequency-specific fading and interference characteristics; time diversity, which communicates the same information at different time intervals to mitigate the effects of transient interference or fading; polarization diversity, which communicates signals using different polarizations (or polarization orientations) to mitigate polarization-specific environmental effects; angle diversity, which communicates signals over multiple transmission paths at different angles to avoid signal obstructions or reflections that impact a single path; etc.

Some conventional satellite communication networks employ one or more diversity approaches, albeit in connection with very-high-throughput satellite (VHTS) RF feeder link implementations. For example, such conventional approaches tend to make diversity decisions in the ground segment. While such conventional diversity techniques can be effective in VHTS RF contexts, they tend not to be useful in FSO link communication contexts. For example, ground segment reaction times tend either to be too slow or are alternatively configured with hair-triggered response times that are too fast; and satellite payload reconfigurations in response to the ground segment diversity decisions tend to take too long.

Embodiments described herein provide novel diversity approaches for satellite communication networks that use the FSO frequency band for feeder-link communications. Embodiments achieve very rapid diversity switching among RF gateway sites by placing the diversity switching decisions and implementations within the satellite payload. In some embodiments, the same feeder-link uplink signal is transmitted from several (e.g., all) of a large number of geographically (spatially) diverse RF gateway sites to the satellite(s). Each feeder-link uplink signal contains the same information bits (i.e., redundant bits). The multiple RF gateways can be deployed based on a worst-case weather pattern in one or more geographic regions. It can be assumed, therefore, that signals from at least one such gateway site will not suffer any particular type of attenuation from atmospheric impairments, which tend to be relatively localized. Although described in context of FSO link communications, the novel diversity approaches described herein can also be applied to millimeter-wave RF bands, such as E-band and higher (sub-THz) bands with some changes.

A typical state-of-the-art, multibeam satellite communication system operating at typical satellite RF frequency bands (e.g., Ka/V band frequencies) tends to deploy a very-high-throughput satellite (VTS) and multiple RF gateways that re-use the feeder-link frequency among them. These RF gateways are geographically separated by enough distance to avoid co-channel interference. The VTS can have multiple feed horns to receive beams from the multiple RF gateways. In this state-of-the-art system, one RF gateway is typically configured as a designated backup and the others are configured as primary RF gateways. When one of the primary RF gateways is incapacitated, such as due to rain, power outage, or another reason, the backup RF gateway becomes active. In such a case, a switch occurs in the satellite payload to move the gateway beam from the down or lost RF gateway to the designated backup RF gateway.

While such state-of-the-art diversity schemes can work with conventional RF gateways ad RF feeder links, such schemes do not work with FSO-based feeder links. As noted above, an optical band signal gets attenuated by the presence of small local clouds and atmospheric turbulence. Therefore, schemes based on a designated backup RF gateway, whether using 1:N or M:N redundancy, tend not to be suitable. For example, one of the RF gateways is kept free or idle and is designated as a backup gateway. When another of the RF gateways experiences fade or failure, affected communications can be switched to the designated backup gateway.

Some embodiments described herein provide full diversity for optical band feeder links without designated backup RF gateways; rather, all RF gateways can transmit the same uplink (e.g., redundant signals) for path diversity. In some cases, for example if desired based on weather patterns in a region, the diverse FSO-based RF gateways can be placed closer to each other as compared to the case of non-optical RF frequency bands. This is because the attenuation due to clouds and atmospheric turbulence may be very localized in some regions. Since in optical frequency band it is possible to form pencil beams (highly directive), RF gateways can be placed in near proximity and can still achieve isolation. Alternatively, optical RF gateways can be placed very far apart. For example, large spacing between gateways can be desirable in regions prone to hurricanes where cloud cover can stretch over 1,000 miles or more.

Different embodiments can use different diversity approaches, such as based on the capability of the satellite payload. The different approaches can be used by the satellite to determine the best signal among multiple transmissions from multiple RF gateways to achieve a very high degree of diversity. According to some embodiments, the multiple RF gateways send redundant feeder-link signals (i.e., signals carrying the same content) without frequency reuse (i.e., using non-overlapping frequency sub-bands). In such embodiments, not much signal processing is performed by the satellite, except that the satellite analyzes multiple signals and uses a predetermined diversity selection scheme to retrieve the best of the signals according to one or more predetermined selection criteria. Indeed, sending redundant information concurrently over multiple signals in multiple sub-bands can be considered as a non-issue in these contexts because of the abundant availability of optical bandwidth. As such, this approach can be relatively low cost and simple to implement from the point of view of the satellite payload.

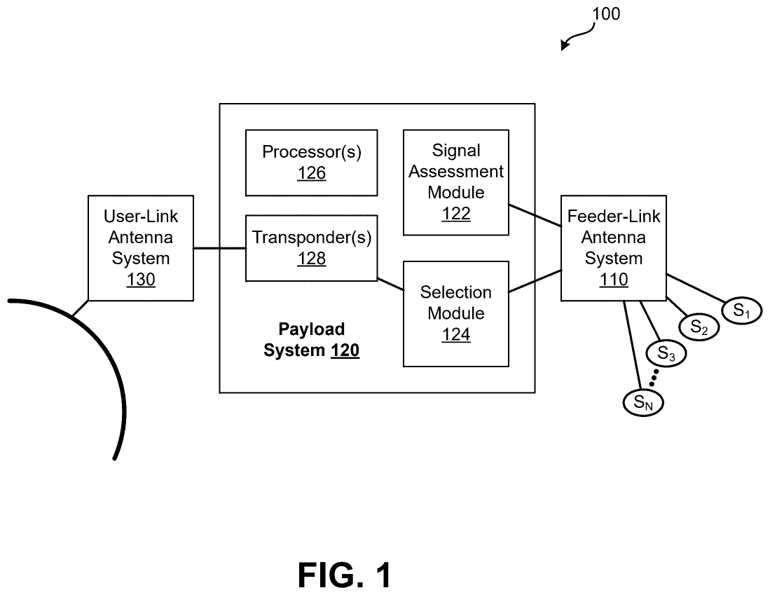

FIG. 1 shows a block diagram of an illustrative implementation of a satellite 100 with payload-based diversity switching for optical feeder-links, according to embodiments described herein. As illustrated, the satellite 105 has a feeder-link antenna system 110, a payload system 120, and a user-link antenna system 130. In some embodiments, the satellite 100 is a geostationary Earth orbit (GEO) spacecraft. As described herein, the GEO satellite 100 can be configured to enhance communication reliability by utilizing free-space optical (FSO) feeder links in a non-processing, bent-pipe configuration. In embodiments using a non-processing satellite 100, the satellite 100 directly relays communication signals from the feeder-link antenna system 110 to the user-link antenna system 130 without on-board signal regeneration or complex processing. By operating in a GEO position, the satellite maintains a fixed position relative to the Earth's surface, providing consistent coverage and enabling continuous communication with both geographically diverse gateway terminals via feeder links and with user terminals via user links. As described herein, the satellite 100 autonomously selects a best (e.g., optimal) FSO feeder link from among multiple FSO feeder links based on signal quality measurements, thereby mitigating effects of localized atmospheric impairments on FSO communications.

Embodiments of the feeder-link antenna system 110 are configured to concurrently receive multiple, redundant free-space optical (FSO) feeder uplink signals, designated as S₁, S₂, S₃, ..., Sₙ. Each FSO feeder uplink signal is received via an FSO uplink portion of a respective one of a plurality of FSO links. These FSO links communicatively couple the feeder-link antenna system 110 with a respective one of multiple geographically diverse gateway terminals (not shown) on the ground. The feeder-link antenna system 110 can include multiple high-sensitivity optical receivers equipped with precise pointing and tracking capabilities to capture the highly directional FSO signals. These receivers may include adaptive optics to correct for atmospheric distortions such as turbulence and scintillation. The use of multiple receivers allows the satellite to receive identical information-bearing signals from different locations, providing spatial diversity to mitigate the effects of localized atmospheric impairments like clouds and fog.

As noted above, signals S₁, S₂, S₃, ..., Sₙ represent the multiple redundant FSO feeder uplink signals, each transmitted from a respective one of multiple gateway terminals. Each gateway terminal is located at a geographically diverse site to provide spatial diversity, thereby mitigating localized atmospheric impairments that can disrupt FSO communication links. By receiving identical signals from different locations, the satellite 100 can increase the probability that at least one of the signals is free from significant degradation due to clouds, precipitation, or other atmospheric phenomena. In some implementations, the gateway terminals transmit on the same optical frequency. In other implementations, the gateway terminals transmit on different optical frequencies.

Embodiments of the user-link antenna system 130 transmit processed data to user terminals (not shown) on Earth. The user-link antenna system 130 includes one or more antennas and associated hardware capable of generating and directing RF beams towards designated coverage areas. The user-link antenna system 130 can use reflector antennas with deployable reflectors, phased array antennas for beam steering and shaping, or a combination thereof to optimize coverage and capacity. Embodiments of the user-link antenna system 130 are configured to maintain high gain and precision to ensure reliable communication with user terminals, which can include fixed, mobile, or portable devices.

Embodiments of the payload system 120 perform signal processing and management functions. As illustrated, the payload system 120 can include a signal assessment module 122, a selection module 124, one or more processors 126, and one or more transponders 128. Embodiments of the signal assessment module 122 measure one or more signal quality indicators (SQIs) of each received FSO feeder uplink signal. In some implementations, the SQIs include a received signal strength indicator (RSSI) of the received FSO feeder uplink signals. In some implementations, the SQIs include a signal-to-noise ratio (SNR) of the received FSO feeder uplink signals. In some implementations, the SQIs include a bit error rate (BER) of the received FSO feeder uplink signals. In some implementations, the SQIs include an energy per symbol to noise power spectral density ratio (Es/No) of the received FSO feeder uplink signals. The signal assessment module 122 can use advanced digital signal processing techniques and real-time monitoring to evaluate the integrity and performance of each uplink signal. Embodiments of the signal assessment module 122 are implemented using specialized processors or field-programmable gate arrays (FPGAs) designed for high-speed signal analysis and capable of operating under the harsh conditions of space.

Embodiments of the selection module 124 are configured to autonomously select one of the received FSO feeder uplink signals based on the measured SQIs. By applying predefined selection criteria, such as choosing the signal with the highest SNR or the lowest BER, the selection module ensures that the best available signal is used for onward transmission. For example, at any particular selection time, the signal assessment module 122 measures one or more present SQI values and reports relevant information to the selection module 124; and the selection module 124 uses the reported present information to make its selection. The autonomous selection process facilitates dynamic adaptation to changing atmospheric conditions, effectively bypassing impaired signals without ground-based intervention. Embodiments of the selection module 124 are implemented using software-based controllers and/or dedicated hardware circuits optimized for rapid decision-making and signal routing.

Embodiments of the transponders 128 facilitate frequency conversion and amplification between the feeder-link antenna system 110 and the user-link antenna system 130. For example, in the forward direction, the transponders 128 facilitate frequency conversion and amplification for downlink transmission to user terminals; and in the return direction, the transponders 128 facilitate frequency conversion and amplification for downlink transmission to gateway terminals. In the forward direction, data can be derived from the selected FSO feeder uplink signal, and the transponders 128 can facilitate conversion of the data from the optical domain to an appropriate radio frequency (RF) spectrum used for user downlink communication (e.g., Ka-band). The transponders 128 can amplify the RF signal to protocol-defined (and/or otherwise defined) power levels while maintaining signal quality and compliance with regulatory requirements. Embodiments of the transponders 128 can be implemented using high-efficiency traveling-wave tube amplifiers (TWTAs) or solid-state power amplifiers (SSPAs), along with frequency converters and filters designed to handle wide bandwidths and high data rates.

In the return direction, embodiments of the payload system 120 exploit the forward-direction features of the signal assessment module 122 and the selection module 124. In particular, the selection of the best FSO uplink signal by the selection module 124 based on the SQI measurements from the signal assessment module 122 yields a selection of the FSO link associated with the one of the gateway terminals 210 from which the selected FSO uplink signal was received. That same FSO link can be considered as having an uplink portion (via which the selected FSO uplink signal was received) and a downlink portion. While the particular FSO link is selected for feeder uplink use, embodiments can use the downlink portion of the same FSO link (and the associated gateway terminal 210) for feeder downlink communications. For example, to conserve power and resources, the satellite 205 can transmit the downlink only to the gateway terminal 210 from which the best uplink signal was received, thereby leveraging the symmetric nature of the FSO links (i.e., if the FSO link has low atmospheric impairment on the uplink, it likely also has substantially the same low atmospheric impairment on the downlink) and the high directivity of the optical beams. By aligning the downlink transmission with the selected uplink gateway terminal 210, the satellite 205 can avoid broadcasting the same downlink signal to multiple gateway terminals 210 simultaneously, which can help to conserve power.

Although not explicitly shown, some embodiments of the payload system 120 include additional modules to enhance functionality and security. Some embodiments of the payload system 120 include a synchronization module to align signals received on the same optical frequency. Some embodiments of the payload system 120 include a security module to validate the authenticity of received signals. In some such embodiments, FSO feeder uplink signals can include secure pilot signals, and the security module can validate the authenticity of received signals based on the pilot signals. In other such embodiments, the security module performs cryptographic verification to protect against intentional interference or jamming.

Components and features of the payload system 120, including features of at least the signal assessment module 122 and the selection module 124, are controlled by the one or more processor(s) 126. The processor(s) 126 can also process the selected FSO feeder uplink signal, such as by performing modulation and demodulation, error correction, coding and decoding, data formatting, and/or other tasks to prepare the signal for downlink transmission to user terminals and gateway terminals. Embodiments of the processor(s) 126 can be implemented using radiation-hardened microprocessors, application-specific integrated circuits (ASICs), FPGAs, digital signal processors (DSPs), system-on-chip (SoC) solutions, general-purpose processors with high-performance computing capabilities, graphics processing units (GPUs), neural processing units (NPUs) or artificial intelligence accelerators, multicore processors, and/or any processors suitable for handling high data throughput and complex signal processing algorithms necessary for advanced communication systems.

In operation, the satellite 100 leverages path diversity to maintain high-reliability communication. For example, the feeder-link antenna system 110 captures incoming FSO feeder uplink signals from ground-based gateway terminals. The signal assessment module 122 evaluates each signal's quality in real-time, providing metrics to the selection module 124. Based on the assessment, the selection module 124 autonomously selects the optimal signal at the selection time for further processing. This process can involve rapid switching between signals as atmospheric conditions change, ensuring continuous and high-quality data flow. Once a signal is selected, the processor(s) 126 perform necessary data processing tasks, and the transponders 128 can handle frequency conversion and amplification, thereby preparing the data for downlink transmission to user terminals. The user-link antenna system 130 transmits the data to the user terminals via user links.

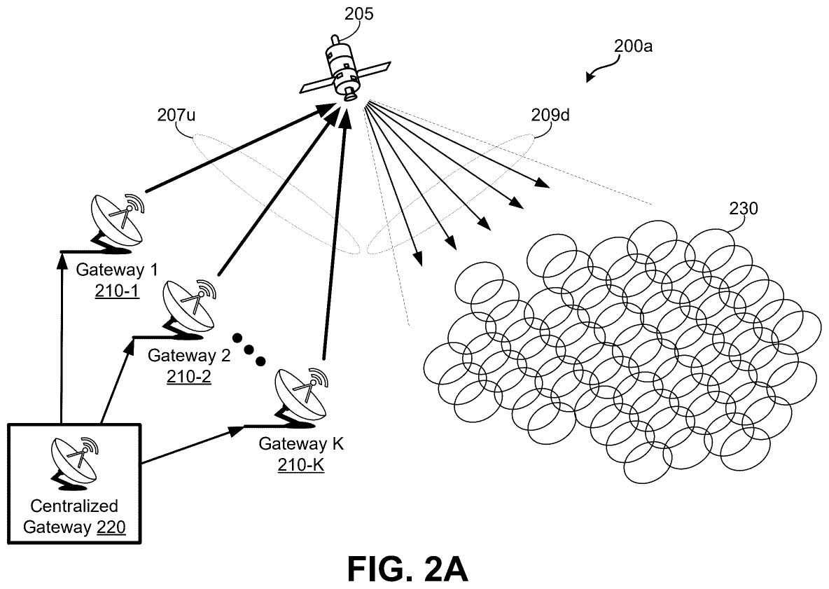

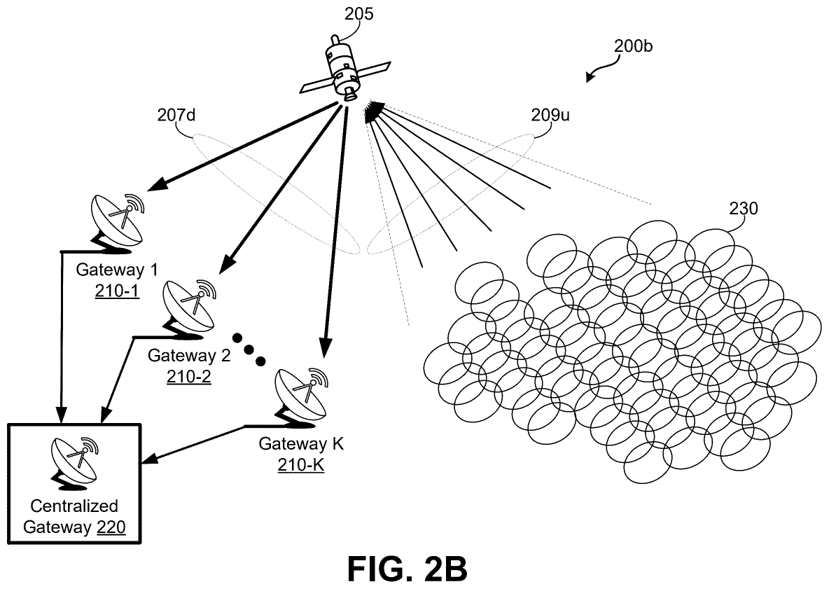

FIGS. 2A and 2B illustrate forward and return communication directions, respectively in a system topology 200 that facilitates protocol division between distributed gateway sites and a central site, according to embodiments described herein. The system topology 200 extends from the satellite 100 description of FIG. 1 and illustrates how processing responsibilities can be partitioned between centralized and distributed components in a satellite communication network utilizing free-space optical (FSO) feeder links.

In both of FIGS. 2A and 2B, the system topology 200 shows remote radio heads (RRHs) and baseband unit (BBU) pools partitioned between distributed gateway terminals 210 and a central gateway 220. As illustrated, the central gateway 220 is communicatively coupled with K geographically distributed gateway terminals 210 (indicated as “Gateway 1” 210-1 through Gateway K 210-K, where K is an integer greater than 2). The coupling can be via high-speed optical fiber backhaul links.

In the forward communication direction illustrated in FIG. 2A, the central gateway 220 serves as the hub for digital baseband processing tasks. These tasks can include higher-layer operations such as scheduling, modulation and demodulation, code block formation, synchronization, and other signal processing functions. The central gateway 220 processes the user data and generates modulated signals, such as in-phase and quadrature (I/Q) samples, which are representative of the communication signals to be transmitted. The modulated data is then relayed from the central gateway 220 to each of the distributed gateway terminals 210 via high-speed optical fiber backhaul links. The use of dedicated fiber optic links helps to ensure low-latency and high-bandwidth communication between the central gateway 220 and the distributed gateway terminals 210, facilitating precise timing and synchronization.

Each distributed gateway terminal 210 can function as a remote radio head (RRH). The distributed gateway terminals 210 receive the modulated signals from the central gateway 220 over the fiber optic links. Upon receipt, each distributed gateway terminal 210 performs up-conversion of the modulated signals to optical frequencies suitable for free-space optical (FSO) transmission to the satellite 205. This process involves converting the electrical baseband signals into optical signals using optical transmitters equipped with lasers or other light-emitting devices capable of generating the required optical wavelengths. The distributed gateway terminals 210 transmit the upconverted signals to the satellite 205 via FSO uplinks 207u. The FSO uplinks 207u are highly directional, involving precise alignment and tracking mechanisms to maintain the optical link between the distributed gateway terminals 210 and the satellite 205. The use of multiple distributed gateway terminals 210 provides spatial diversity, enhancing the reliability of the communication system by mitigating the effects of localized atmospheric impairments such as clouds and fog.

The satellite 205 also communicates with user terminals on Earth via user downlinks 209d and user uplinks 209u. In the forward communication direction shown in FIG. 2A, the satellite 205 transmits user downlink signals 209d to user terminals. These signals are facilitated by beams 230, which represent the radio frequency (RF) communication paths between the satellite 205 and the user terminals. The satellite's 205 user-link antenna system 130 generates and directs these beams 230 towards designated coverage areas on Earth. The beams 230 can form multiple spot beams to provide high-capacity and flexible coverage tailored to user demand. The RF downlinks operate at frequencies suitable for user terminals, such as the Ka-band, and are designed to deliver data services with high reliability and efficiency.

In the return communication direction illustrated in FIG. 2B, the user terminals transmit user uplink signals 209u to the satellite 205. These user uplinks 209u consist of RF signals sent from the user terminals to the satellite 205. The user-link antenna system 130 on the satellite 205 receives these uplink signals. The user-link antenna system 130 employs high-sensitivity receivers and may utilize techniques such as beamforming and beam steering to optimize signal reception from the user terminals. The received user uplink signals 209u are then processed by the satellite's payload system, which may include frequency conversion and amplification, before being relayed to the appropriate one of the distributed gateway terminals 210.

The satellite 205 transmits data to the distributed gateway terminals 210 via FSO downlinks 207d. Each distributed gateway terminal 210 receives the optical downlink signals from the satellite 205 using high-sensitivity optical receivers equipped with adaptive optics to correct for atmospheric distortions. Upon receipt, each distributed gateway terminal 210 performs down-conversion, converting the optical signals back into electrical baseband signals. These signals are then forwarded to the central gateway 220 over the high-speed optical fiber backhaul links for further processing. The central gateway 220 performs tasks such as demodulation, error correction, decoding, and higher-layer protocol processing to retrieve the user data from the received signals.

The partitioning of functions between the central gateway 220 and the distributed gateway terminals 210 allows for efficient utilization of resources and centralized management of the communication system. By handling complex signal processing tasks at the central gateway 220, the distributed gateway terminals 210 are simplified to primarily perform frequency conversion and transmission functions. This configuration reduces the computational requirements and costs at each distributed gateway terminal 210 while leveraging the central gateway's 220 capabilities for intensive processing and coordination. Additionally, the centralized architecture facilitates easier implementation of network-wide updates, security measures, and synchronization protocols.

The high-speed optical fiber backhaul links provide high-bandwidth and low-latency communication channels for transferring large volumes of modulated data between the central gateway 220 and the distributed gateway terminals 210. The optical fiber links can also support robust synchronization mechanisms to help the distributed gateway terminals 210 operate in unison and maintain alignment with the satellite's 205 communication protocols.

In embodiments where the modulation and demodulation functions are performed at the distributed gateway terminals 210 instead of the central gateway 220, the system topology 200 can adjust accordingly. In such configurations, the distributed gateway terminals 210 handle both the baseband signal processing and the frequency conversion tasks. The central gateway 220, connected to the distributed gateway terminals 210 via a backhaul network, focuses on higher-layer processing such as networking and link layer protocols. This arrangement reduces the dependency on high-speed optical fiber links and allows for more flexibility in the placement and operation of the distributed gateway terminals 210. However, achieving time and phase synchronization in this configuration can involve additional coordination, possibly at the satellite 205.

The system topology 200 supports various diversity strategies to enhance communication reliability and capacity. By utilizing multiple distributed gateway terminals 210 transmitting identical or overlapping spectra, the system can implement full or partial replication of the feeder link signals. Full replication involves each distributed gateway terminal 210 transmitting the entire satellite spectrum to the satellite 205, providing redundancy and maximizing the likelihood of successful communication despite localized impairments. Partial replication involves transmitting overlapping or different portions of the spectrum from different distributed gateway terminals 210, optimizing spectrum usage while still leveraging diversity benefits.

The high directivity of FSO links allows for efficient frequency reuse across the distributed gateway terminals 210 with minimal co-channel interference. This characteristic facilitates the deployment of multiple distributed gateway terminals 210 in relatively close proximity or across large geographical areas. The spatial diversity achieved through this deployment enhances the system's ability to mitigate atmospheric impairments and maintain high-capacity communication links.

Security considerations can be integrated into the system topology 200 to protect against potential interference or jamming. The centralized architecture facilitates implementation of robust authentication and validation mechanisms at the central gateway 220. Secure pilot signals or control channels can be utilized to verify the integrity of the signals received from the distributed gateway terminals 210. The system can also implement power threshold checks and/or correlation techniques to detect and mitigate unauthorized signal sources or attempts to hijack the communication links.

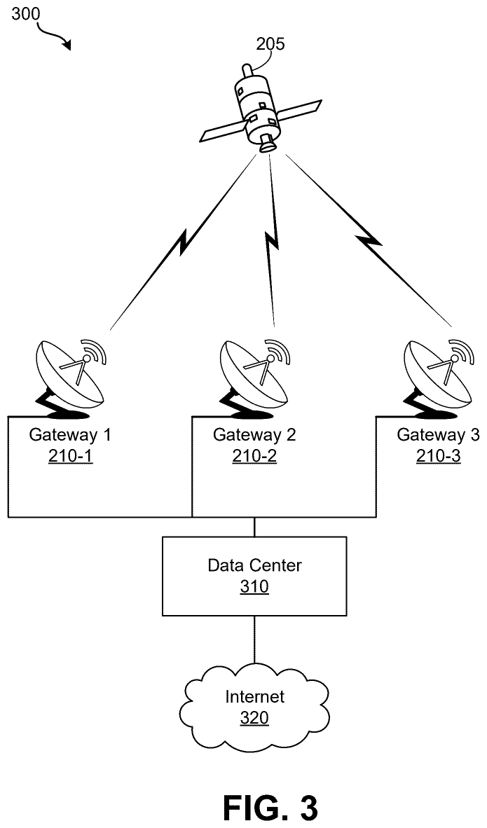

FIG. 3 illustrates a system topology 300 depicting an alternative architecture where modulation and demodulation functions are performed at distributed gateway terminals 210, according to embodiments described herein. This configuration differs from the centralized processing approach described in FIGS. 2A and 2B by decentralizing certain processing tasks to the individual gateway terminals 210. The system topology 300 extends the concepts from the satellite communication network utilizing free-space optical (FSO) feeder links and demonstrates how processing responsibilities can be partitioned to optimize resource utilization and network performance.

The illustrated topology 300 includes multiple distributed gateway terminals 210 and a data center 310, all interconnected between a satellite 205 and the Internet 320. Specifically, Gateway 1 (210-1), Gateway 2 (210-2), and Gateway 3 (210-3) are shown as individual gateway terminals that are geographically dispersed. Although three gateway terminals 210 are shown, any suitable number of gateway terminals 210 can be included. Each of the gateway terminals 210 is directly connected to the data center 310 via a backhaul network. The data center 310 serves as a central node for networking and link-layer processing, handling tasks such as routing, network management, and higher-layer protocol functions. The Internet 320 is connected to the data center 310, facilitating communication between the satellite network and external networks or services.

In the illustrated topology 300, modulation and demodulation functions can be performed locally at each distributed gateway terminal 210. Each gateway terminal 210 handles both baseband signal processing and radio frequency (RF) processing. This includes tasks such as modulation, demodulation, encoding, decoding, error correction, and signal synchronization at the physical layer and lower parts of the medium access control (MAC) layer. By performing these functions locally, the distributed gateway terminals 210 can operate more autonomously and reduce reliance on centralized processing resources.

The distributed gateway terminals 210 are connected to the data center 310 via a backhaul network, which can utilize various communication technologies such as microwave links, leased lines, or the public Internet. The backhaul network can use high-speed optical fiber backhaul links as in FIGS. 2A and 2B, but the illustrated topology 300 does not rely on the same level of high-bandwidth or low-latency infrastructure support. Implementations also may not include time and phase synchronization between the distributed gateway terminals 210, and any desired time and phase coherency between multiple uplink signals can be performed instead at the satellite 205.

Each distributed gateway terminal 210 transmits uplink signals to the satellite 205 via free-space optical (FSO) uplinks. The satellite 205 receives these uplink signals (e.g., which may not be time and phase synchronized due to a lack of ground-based synchronization). To ensure proper signal reception and to maximize the benefits of spatial diversity and frequency reuse, the satellite 205 can employ advanced signal processing techniques to achieve time and phase alignment of the received signals, if desired.

The satellite 205 processes the received uplink signals from the distributed gateway terminals 210 and transmits downlink signals back to the user terminals or to the gateway terminals 210. In this architecture, the satellite 205 can include additional processing capabilities to handle synchronization and signal combining tasks. This can place more processing responsibility on the satellite but can also reduce the complexity and cost associated with maintaining high-speed, synchronized backhaul links between the data center 310 and the distributed gateway terminals 210.

Embodiments of the data center 310 can handle networking and link-layer processing tasks. This includes routing data packets to and from the Internet 320, managing network protocols, and performing higher-layer functions such as session management, security, and quality of service (QoS) enforcement. By centralizing these functions at the data center 310, the network can efficiently manage data flow and maintain consistent policies across the distributed gateway terminals 210.

The “Internet” 320 is intended generally to represents external networks and services that are accessible through the satellite communication network. The connection between the data center 310 and the Internet 320 allows user terminals connected via the satellite 205 to access Internet services, transmit and receive data, and communicate with other networked devices. The data center 310 acts as a gateway between the satellite network and the broader Internet, translating protocols and managing data traffic to ensure seamless connectivity.

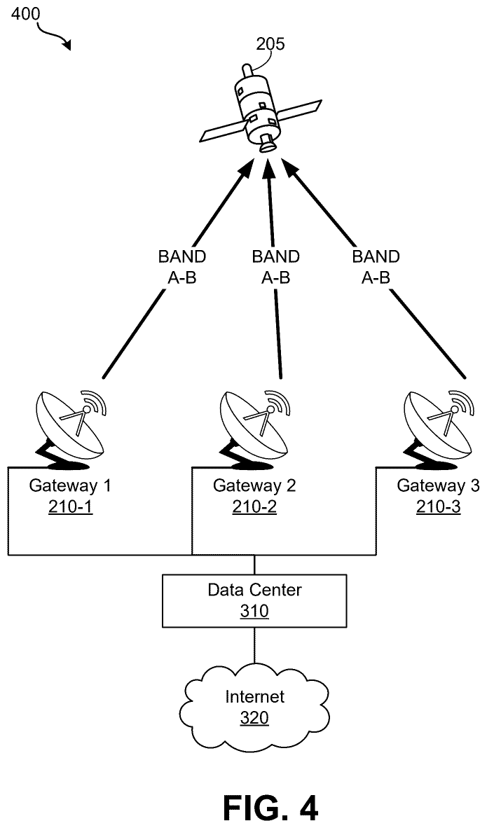

FIG. 4 illustrates a system topology 400 depicting the full replication of the feeder link model in a satellite communication network utilizing free-space optical (FSO) feeder links, according to embodiments described herein. This model demonstrates how each of the gateway terminals 210 (i.e., radio frequency (RF) gateways) simultaneously transmits the same uplink signal, encompassing the same (e.g., entire) satellite spectrum, to the satellite 205. Similar to FIG. 3, the topology 400 of FIG. 4 includes multiple distributed gateway terminals 210 (only three are shown, but any suitable number can be used) and a data center 310 interconnected between a satellite 205 and the Internet 320. Each of the gateway terminals 210 is connected to the data center 310, and the data center 310 serves as a central node for networking and higher-layer processing, managing tasks such as routing, network management, and interface with external networks.

Each gateway terminal 210 transmits the same uplink signal over the same (e.g., entire) spectrum allocated to the satellite 205. This approach is referred to as “full replication” or “duplication” of the feeder link. The gateway terminals 210 utilize FSO uplink paths to transmit these signals to the satellite 205. Due to the vast amount of available spectrum in the optical band, simultaneously transmitting the entire satellite spectrum from multiple gateway terminals 210 does not pose significant spectrum usage issues. The optical frequencies used for transmission can be either the same across all gateway terminals 210, employing a frequency reuse strategy, or different for each gateway terminal 210, implementing multi-frequency diversity.

In the frequency reuse scenario, the same frequency band is transmitted from each gateway terminal 210. The high directivity of FSO links enables this frequency reuse with minimal co-channel interference, as the likelihood of signal overlap between the highly focused beams is significantly reduced. Each gateway terminal 210 employs precise beam steering and alignment mechanisms to ensure that the optical signals are accurately directed towards the satellite 205. Advanced tracking systems may be implemented to compensate for factors such as atmospheric disturbances and satellite movement.

In the multi-frequency diversity scenario, different optical frequencies are assigned to each gateway terminal 210. This approach reduces the potential for interference even further and can enhance the robustness of the communication links by providing frequency diversity. The satellite 205 is equipped with the necessary optical receivers and filters to accommodate multiple frequencies simultaneously, allowing it to receive and process the uplink signals from all gateway terminals 210.

By utilizing full replication of the feeder link, the system achieves spatial diversity, effectively mitigating the effects of atmospheric impairments such as clouds, fog, rain, or other weather-related phenomena that may affect individual gateway terminals 210 differently. Since atmospheric conditions are often localized, the probability that all gateway terminals 210 are simultaneously impaired is significantly reduced. This redundancy ensures that the satellite 205 almost always has access to at least one high-quality feeder uplink signal.

As described herein, embodiments strategically determine the locations of the diverse gateway terminals 210 to ensure spatial separation, thereby minimizing the probability that all gateway terminals 210 experience simultaneous impairment due to localized weather phenomena such as clouds or fog. FSO communication's highly directive transmission further supports this approach by reducing co-channel interference, even when identical uplink signals are transmitted to the satellite 205. The placement of gateway terminals 210 can be informed by worst-case weather conditions in the region, allowing the system to maintain operational efficiency during adverse atmospheric conditions. Unlike conventional systems that rely on designated primary and backup RF gateways, embodiments can use all gateway terminals 210 to actively transmit uplink signals. The satellite 205 (payload system 120) autonomously selects the best signal based on real-time signal quality assessments, dynamically adapting to changing atmospheric conditions. This dynamic selection adapts to changing atmospheric conditions, as the optimal uplink may shift from one gateway terminal 210 to another over time due to the random nature of cloud movement and weather patterns.

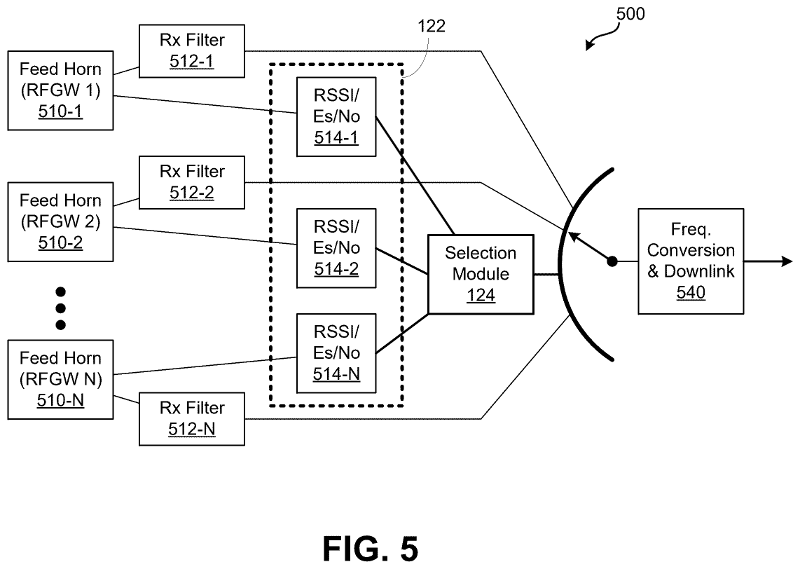

FIG. 5 illustrates a sample receive architecture 500 to implement rapid, dynamic payload-side selection for extracting a best signal from among multiple redundant uplinks. In the illustrated configuration, each gateway terminal 210 transmits a feeder uplink at a different frequency from all others (i.e., space-frequency diversity). Such an approach uses a larger amount of optical spectrum but simplifies the selection process on the satellite 205 and avoids the complexity associated with signal combining, or other techniques.

As illustrated, the satellite's feeder-link antenna system 110 receives uplink signals through multiple feed horns 510 (shown as 510-1, 510-2, ..., 510-N), each associated with a different respective gateway terminal 210. Each received signal passes through a respective receive (Rx) filter 512 (shown as 512-1, 512-2, ..., 512-N) to ensure proper frequency separation and to mitigate potential interference. Following filtering, the signals are analyzed by components of a signal assessment module 122 illustrated as “RSSI/Es/No” measurement units 514 (514-1, 514-2, ..., 514-N). The units 514 assess SQIs, such as received signal strength indicator (RSSI), signal-to-noise ratio (SNR), energy per symbol to noise power spectral density ratio (Es/No), etc.

As described herein, the units 514 provide SQI data to a selection module 124, which evaluates the quality of each signal based on predefined selection criteria. The selection criteria include at least the SQIs. In some embodiments, the selection is based on comparing SQI measurements to predefined thresholds to ensure that the chosen signal meets at least minimum quality requirements for reliable communication. In some implementations, if multiple signals meet the criteria, the selection module 124 can select the signal with the highest quality metric. In other implementations, if multiple signals meet the criteria, the selection module 124 can retain the previously selected signal to minimize potential disruptions during transitions.

As described herein, once the best uplink signal is selected, it can pass through processing, transponders, etc., such as going through frequency conversion and downlink transmission (illustrated generally as frequency conversion and downlink module 540) to user beams. The frequency conversion involves translating the optical frequency of the uplink signal to an appropriate downlink RF band (e.g., Ka-band) used for communication with user terminals. The frequency conversion and downlink module 540 generally ensures that the signal is compatible with the user-link antenna system and adheres to necessary communication protocols.

By selecting the best signal allows for real-time adaptation to changing atmospheric (e.g., and other) conditions. However, due to factors, such as use of different frequencies by different gateway terminals 210 in some implementations, lack of synchronization at the ground level in some implementations, etc., the uplink signals may arrive at the satellite 205 with different time delays and phases. This lack of time and phase coherence can lead to potential code block losses during diversity switching, particularly if the newly selected uplink signal is ahead of the previously selected one. Despite the potential for minor discontinuities during signal transitions, embodiments are designed to minimize the impact on overall communication quality. Higher-layer protocols and error correction mechanisms can be used to recover lost code blocks, ensuring seamless service to end-users without relying on complex synchronization or signal processing techniques on the satellite 205.

Some embodiments include security features for mitigating risks, such as intentional interference or jamming. For instance, a malicious entity could generate a high-power optical signal near the beam location of a gateway terminal 210, which can potentially deceive the satellite's 205 selection mechanism into prioritizing the interferer's signal. Some embodiments incorporate a predefined maximum power threshold within the selection module 124 (e.g., or alternatively as part of the signal assessment module 122). In such embodiments, the selection module 124 avoids selecting an uplink signal that exceeds the predefined maximum power threshold. This can prevent the selection of suspiciously strong signals that may result from interference or jamming.

In some implementations, each gateway terminal 210 transmits a secure pilot signal along with its FSO uplink transmission (e.g., the carrier modulated with a secure pilot signal). The satellite payload demodulates the pilot signal. Embodiments of the signal assessment module 122 correlate the demodulated pilot signal with a known reference to validate the authenticity of the received signal. For example, the modulated carrier can come with some built-in security key, and the payload can select the feeder-link which has the best selection control carrier. The control carrier is sent within the same frequency band as the FSO uplink signal so as to be representative of propagation path cloud attenuation. Some embodiments of the signal assessment module 122 pass signals through to the selection module 124 based on whether those signals can be validated. For example, the correlation ensures that only legitimate signals from authorized gateway terminals 210 are considered during the selection process.

Some embodiments of the signal assessment module 122 further include advanced algorithms analyze the relationship between the pilot signal power and the overall traffic spectrum power to detect anomalies indicative of interference. There may be scenarios in which a nefarious entity attempts to hack the pilot signal or control carrier. For example, a jammer jams traffic while also being aware of how to avoid the selection of control carrier and/or to mimic the pilot signal. In such embodiments, the payload can select the feeder-link which has the best selection control carrier, measure traffic spectrum power, and apply a predetermined maximum power threshold (e.g., the same threshold described above). As a simplified example, assume that the selection carrier has been measured at power of X dBm, and the traffic spectrum which has gone through the same line-of-sight propagation path as a power of 2X dBm. Here, the advanced algorithms may detect that, although the pilot signal appears to correlate, its anomalous power is indicative of interference and the signal should be avoided accordingly.

Embodiments further optimizes the feeder-link downlink from the satellite 205 to the gateway terminals 210. Once the feeder uplink selection is made, embodiments use the same FSO link with the same gateway terminal 210 for the feeder downlink. For example, instead of transmitting the same downlink spectrum to multiple gateway terminals 210 simultaneously, which would involve appreciable satellite resources, the satellite payload can direct the downlink signal exclusively to the gateway terminal 210 associated with the selected FSO uplink. Due to the high directivity and symmetry of FSO links, the atmospheric conditions affecting the uplink path are likely similar to those impacting the downlink path. By aligning the downlink transmission with the selected uplink gateway terminal 210, embodiments can conserve resources while maintaining high-quality communication.

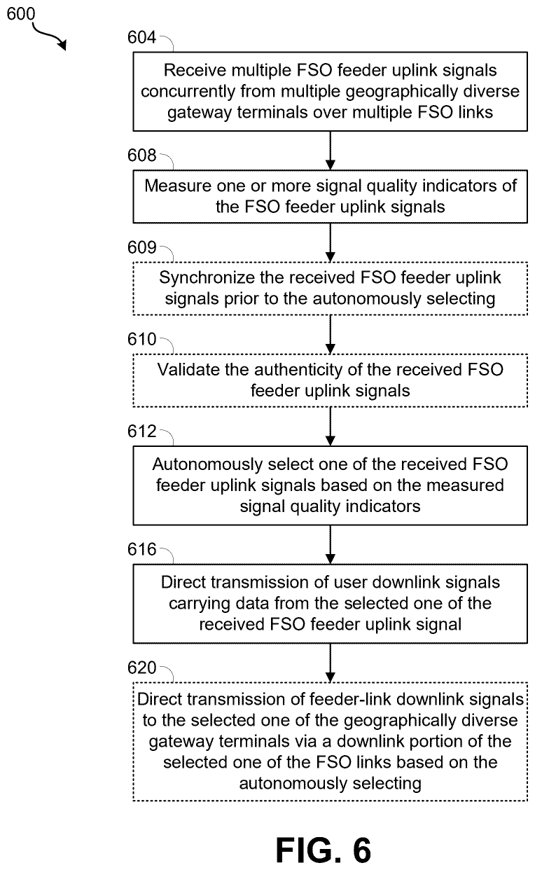

FIG. 6 shows a flow diagram of a method 600 for payload-based diversity switching for satellite optical feeder-links, according to embodiments described herein. Embodiments of the method 600 begin at stage 604 by concurrently receiving (e.g., at a feeder-link antenna system of a satellite) multiple free-space-optical (FSO) feeder uplink signals from multiple geographically diverse gateway terminals via uplink portions of multiple corresponding FSO links.

At stage 608, embodiments can measure one or more signal quality indicators of the multiple FSO feeder uplink signals concurrently. As described herein, the measuring of signal quality indicators can include measuring received signal strength indicators (RSSIs) of the received FSO feeder uplink signals, signal-to-noise ratios (SNRs) of the received FSO feeder uplink signals, bit error rates (BERs) of the received FSO feeder uplink signals, and/or energy per symbol to noise power spectral density ratios (Es/Nos) of the received FSO feeder uplink signals.

At stage 612, embodiments can autonomously select one of the received FSO feeder uplink signals based on the signal quality indicators measured in stage 608. In some embodiments, the autonomously selecting at stage 612 involves selecting the FSO feeder uplink signal having the highest measured signal quality indicator. In some embodiments, the autonomously selecting at stage 612 involves applying a predefined selection criterion based on a threshold value of the signal quality indicators.

Some embodiments perform one or more steps in association with the measuring in stage 608 and/or the selecting in stage 612. Some such embodiments, at stage 609, synchronize the received FSO feeder uplink signals (e.g., prior to or as part of stage 608 or 612). For example, in a frequency reuse implementation, the redundant feeder uplink signals are sent from different gateway terminals using partially or completely overlapping frequency bands. In cases where all gateway terminals transmit on the same frequency, all the antennas on the satellite may receive all the signals. In some such cases, the antennas can be configured to be highly directional and/or to use beamforming or other techniques to differentiate among the signals. In other cases, it is desirable to receive multiple of the signals and to synchronize the signals, accordingly.

Some such embodiments, at stage 610, validate the authenticity of each received FSO feeder uplink signal (e.g., prior to or as part of stage 608 or 612). For example, the validating can be based on a secure pilot signal included in the FSO feeder uplink signals, based on a predetermined maximum power threshold, and/or based on other security assessments. In some such embodiments, the autonomously selecting at stage 612 is based on both the measured signal quality indicators and validation of the secure pilot signal by the security module.

At stage 616, embodiments can direct transmission (e.g., to user terminals via a user-link antenna system of the satellite) of user downlink signals carrying data from the selected one of the received FSO feeder uplink signal.

Some embodiments, at stage 620, can direct transmission of feeder-link downlink signals via a downlink portion of the same FSO link associated with the same gateway terminal from which the selected FSO feeder uplink signal was received.

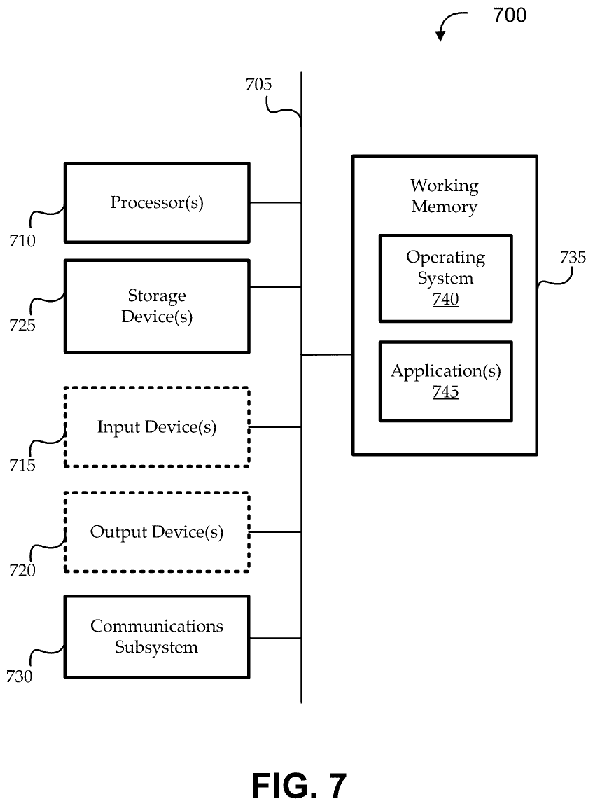

In some embodiments, components of the satellite 205, including components of payload system 120 of FIG. 1, are implemented by a computational system. FIG. 7 provides a schematic illustration of an embodiment of a computational system 700 that can implement various system components and/or perform various steps of methods provided by various embodiments. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computational system 700 is shown including hardware elements that can be electrically coupled via a bus 705 (or may otherwise be in communication, as appropriate). The hardware elements may include one or more processors 710, including, without limitation, one or more general-purpose processors and/or one or more special-purpose processors (such as digital signal processing chips, graphics acceleration processors, video decoders, and/or the like). Optionally, embodiments of the computational system 700 can include one or more input devices 715, and/or one or more output devices 720. The input devices 715 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 720 can include user output devices (e.g., display devices, printers, and/or the like), and/or machine input devices (e.g., computer-to-computer interfaces, such as wired and/or wireless output data ports).

The computational system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like.

The computational system 700 can also include a communications subsystem 730, which can include, without limitation, a modem, a network card (wireless or wired), an infrared communication device, a wireless communication device, a chipset, and/or the like. Embodiments of the communications subsystem 730 can include components of, and/or can interface with, a feeder-link antenna system and/or a user-link antenna system.

The computational system 700 further includes a working memory 735, which can include a RAM or ROM device, as described herein. The computational system 700 also can include software elements, shown as currently being located within the working memory 735, including an operating system 740, device drivers, executable libraries, and/or other code, such as one or more application programs 745, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 740 and the working memory 735 can be used in conjunction with the one or more processors 710 to implement the some or all of the features of the MTIC 140.

A set of these instructions and/or codes can be stored on a non-transitory (or non-transient) computer-readable storage medium, such as the non-transitory storage device(s) 725 described above. In some cases, the storage medium can be incorporated within a computer system, such as computational system 700. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 700 and/or can take the form of source and/or installable code, which, upon compilation and/or installation on the computational system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 700) to perform methods in accordance with various embodiments of the invention. In some embodiments, the non-transitory storage device(s) 725 has instructions stored thereon, which, when executed, cause the processor(s) 710 to perform steps of the method 600 of FIG. 6. According to a set of embodiments, some or all of the procedures of such methods are performed by the computational system 700 in response to processor 710 executing one or more sequences of one or more instructions (which can be incorporated into the operating system 740 and/or other code, such as an application program 745) contained in the working memory 735. Such instructions may be read into the working memory 735 from another computer-readable medium, such as one or more of the non-transitory storage device(s) 725. Merely by way of example, execution of the sequences of instructions contained in the working memory 735 can cause the processor(s) 710 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 700, various computer-readable media can be involved in providing instructions/code to processor(s) 710 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 725. Volatile media include, without limitation, dynamic memory, such as the working memory 735. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a disk of a remote computer. The remote computer can load the instructions into its dynamic memory and send the instructions as signals over a transmission medium to be received and/or executed by the computational system 700. The communications subsystem 730 (and/or components thereof) generally will receive signals, and the bus 705 then can carry the signals (and/or the data, instructions, etc., carried by the signals) to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A satellite comprising:
a feeder-link antenna system configured to concurrently receive multiple free-space-optical (FSO) feeder uplink signals, each FSO feeder uplink signal received via an FSO uplink portion of a respective one of a plurality of FSO links, each FSO link communicatively coupling the feeder-link antenna system with a respective one of a plurality of geographically diverse gateway terminals;
a payload system comprising:
a signal assessment module configured to measure one or more signal quality indicators of the received FSO feeder uplink signals; and
a selection module configured to autonomously select one of the received FSO feeder uplink signals based on the measured signal quality indicators; and
a user-link antenna system configured to transmit, to user terminals, user downlink signals carrying data from the selected one of the received FSO feeder uplink signal.

2. The satellite of claim 1, wherein:
the selected one of the received FSO feeder uplink signals is received from a selected one of the geographically diverse gateway terminals via a selected one of the FSO links; and
the feeder-link antenna system is further configured, based on the autonomously selecting, to transmit feeder-link downlink signals to the selected one of the geographically diverse gateway terminals via a downlink portion of the selected one of the FSO links.

3. The satellite of claim 1, wherein the payload system further comprises:
a synchronization module configured to synchronize the received FSO feeder uplink signals.

4. The satellite of claim 1, wherein the signal assessment module is configured to measure the one or more signal quality indicators by measuring one or more of received signal strength indicators (RSSIs) of the received FSO feeder uplink signals, signal-to-noise ratios (SNRs) of the received FSO feeder uplink signals, bit error rates (BERs) of the received FSO feeder uplink signals, or energy per symbol to noise power spectral density ratios (Es/Nos) of the received FSO feeder uplink signals.

5. The satellite of claim 1, wherein the selection module is configured to select the FSO feeder uplink signal having the highest measured signal quality indicator.

6. The satellite of claim 1, wherein the selection module is configured to select the FSO feeder uplink signal by applying a predefined selection criterion based on a threshold value of the signal quality indicators.

7. The satellite of claim 1, wherein the multiple FSO feeder uplink signals are redundant signals transmitted at a same optical frequency.

8. The satellite of claim 1, wherein the multiple FSO feeder uplink signals are redundant signals transmitted at different optical frequencies.

9. The satellite of claim 1, wherein the payload system further comprises:
a security module configured to validate the authenticity of each received FSO feeder uplink signal based on a secure pilot signal included in the FSO feeder uplink signals.

10. The satellite of claim 9, wherein the selection module is configured to select one of the received FSO feeder uplink signals based on both the measured signal quality indicators and validation of the secure pilot signal by the security module.

11. The satellite of claim 9, wherein:
the security module is further configured to determine whether any of the FSO feeder uplink signals exceeds a maximum power threshold; and
the selection module is configured to avoid selection of any of the FSO feeder uplink signals determined by the security module to exceed the maximum power threshold.

12. The satellite of claim 1, wherein the feeder-link antenna system comprises multiple optical receivers, each configured to receive an FSO feeder uplink signal from a respective one of the plurality of geographically diverse gateway terminals.

13. The satellite of claim 1, wherein:
the signal assessment module is further configured to monitor the one or more signal quality indicators of a presently selected one of the received FSO feeder uplink signals relative to a predetermined threshold; and
the selection module is configured to autonomously select the one of the received FSO feeder uplink signals in place of a presently selected one of the received FSO feeder uplink signals responsive to detecting that the monitored one or more signal quality indicators of the presently selected one of the received FSO feeder uplink signals crossed a predetermined threshold.

14. A satellite payload system comprising:
a feeder-link antenna interface to communicatively couple with a feeder-link antenna system configured to communicate concurrently with a plurality of geographically diverse gateway terminals via a plurality of free-space-optical (FSO) links;
a user-link antenna interface to communicatively couple with a user-link antenna system configured to communicate with a plurality of user terminals via a plurality of user links;
one or more processors coupled with the feeder-link antenna interface and the user-link antenna interface; and
a non-transitory processor readable memory having instructions stored thereon which, when executed, cause the one or more processors to perform steps comprising:
measuring one or more signal quality indicators of multiple FSO feeder uplink signals concurrently received via the feeder-link antenna interface, the multiple FSO feeder uplink signals transmitted by the plurality of geographically diverse gateway terminals over the plurality of free-space-optical (FSO) links; and
autonomously selecting one of the received FSO feeder uplink signals based on the measured signal quality indicators; and
directing transmission, to the plurality of user terminals via the user-link antenna interface and the plurality of user links, of user downlink signals carrying data from the selected one of the received FSO feeder uplink signal.

15. The satellite payload system of claim 14, wherein:
the selected one of the received FSO feeder uplink signals is received from a selected one of the geographically diverse gateway terminals via a selected one of the FSO links; and
the steps further comprise directing transmission of feeder-link downlink signals to the selected one of the geographically diverse gateway terminals via the feeder-link antenna interface and a downlink portion of the selected one of the FSO links based on the autonomously selecting.

16. The satellite payload system of claim 14, wherein the steps further comprise:
synchronizing the received FSO feeder uplink signals prior to the autonomously selecting.

17. The satellite payload system of claim 14, wherein the measuring the one or more signal quality indicators comprises measuring one or more of received signal strength indicators (RSSIs) of the received FSO feeder uplink signals, signal-to-noise ratios (SNRs) of the received FSO feeder uplink signals, bit error rates (BERs) of the received FSO feeder uplink signals, or energy per symbol to noise power spectral density ratios (Es/Nos) of the received FSO feeder uplink signals.

18. The satellite payload system of claim 14, wherein the autonomously selecting comprises selecting the FSO feeder uplink signal having the highest measured signal quality indicator.

19. The satellite payload system of claim 14, wherein the autonomously selecting comprises selecting the FSO feeder uplink signal by applying a predefined selection criterion based on a threshold value of the signal quality indicators.

20. The satellite payload system of claim 14, wherein the steps further comprise:
validating the authenticity of each received FSO feeder uplink signal based on a secure pilot signal included in the FSO feeder uplink signals,
wherein the autonomously selecting comprises selecting the FSO feeder uplink signal based on both the measured signal quality indicators and validation of the secure pilot signal by the security module.
